(19) United States
(12) Patent Application Publication
(10) Pub. No.: US 2025/0353756 A1
(43) Pub. Date: Nov. 20, 2025

(54) METHODS OF INCREASING THE RATE OF PHASE CONVERSION AND USE OF CARBOXYLATE-CONTAINING SUBSTANCES

(71) Applicant: BAOTOU RESEARCH INSTITUTE OF RARE EARTHS, Baotou (CN)

(72) Inventors: Jianguo Cui, Baotou (CN); Jiaxian Yang, Baotou (CN); Baixin Dai, Baotou (CN); Ehu Bolo, Baotou (CN); Haijuan Gao, Baotou (CN); Yvfu Chen, Baotou (CN); Shengqiang Zhang, Baotou (CN)

(73) Assignee: BAOTOU RESEARCH INSTITUTE OF RARE EARTHS, Baotou (CN)

(21) Appl. No.: 18/959,265

(22) Filed: Nov. 25, 2024

(30) Foreign Application Priority Data
May 14, 2024 (CN) 2024105961278

(51) Int. Cl. C01F 17/247

(52) U.S. Cl. CPC C01F 17/247; C01P 2002/72; C01P 2004/03; C01P 2004/62; C01P 2004/64

(57) ABSTRACT

The present disclosure provides a method of increasing the rate of phase conversion and use of a carboxylate-containing substance. A method of increasing the rate of phase conversion in the course of preparing a rare earth hydroxycarbonate from a rare earth carbonate comprises: mixing a rare earth carbonate with an aqueous solution of a carboxylate-containing substance to obtain a slurry; and heating the slurry such that reactions proceed. The method of the present disclosure can improve the rate of conversion from a rare earth carbonate to a rare earth hydroxycarbonate.

### TECHNICAL FIELD OF THE DISCLOSURE

The present disclosure relates to a method of increasing the rate of phase conversion in the course of preparing a rare earth hydroxycarbonate from a rare earth carbonate, a method of preparing a rare earth hydroxycarbonate from a rare earth carbonate, and the use of carboxylate-containing substances.

### BACKGROUND OF THE DISCLOSURE

Because of their special properties in light, heat, electricity, magnetism, wear resistance, corrosion resistance, antibacterial capability, and other aspects, rare earth elements have been used in more and more fields and gained the title “industrial gold” or “industrial vitamin.” Rare earth-related products (e.g., rare earth oxides and rare earth fluorides), when used in high-end fields, need to satisfy stricter quality requirements for purity, particle size, crystal form, type, and other aspects.

Rare earth carbonates and rare earth hydroxycarbonates are precursors for forming rare earth-related products such as rare earth oxides and rare earth fluorides. A rare earth carbonate or a rare earth hydroxycarbonate can be obtained by being precipitated from a rare earth solution, such as a solution of a rare earth chloride, a solution of a rare earth nitrate, and a solution of a rare earth sulfate. However, the following problems generally exist in this regard: (1) As a rare earth carbonate or a rare earth hydroxycarbonate is being precipitated from a rare earth solution, anions in the rare earth solution, such as Cl⁻, SO₄²⁻, and NO₃⁻, remain in diverse forms in the rare earth carbonate or rare earth hydroxycarbonate. Those anions become impurities of downstream functional materials and thereby badly affect the performance of these materials. (2) When conventional equipment is used to precipitate a rare earth carbonate or a rare earth hydroxycarbonate from a rare earth solution, it is difficult to control the particle size of the rare earth carbonate or rare earth hydroxycarbonate, so it is difficult to obtain a rare earth compound having a particle size of 5 μm or less.

CN104310456A discloses a method of producing rare earth carbonates. On a specific precipitation reaction apparatus, a rare earth chloride and a carbonate solution are added in the way of two parallel streams, and the aging time of the rare earth carbonate is controlled by controlling the speed of feeding the raw materials and the speed of discharging the product, which lead to spatial separation of the reaction zone and the crystallization zone. As a result, the product of a rare earth carbonate that has a small particle size and contains a small amount of chloride ions can be directly precipitated from the hydrochloric acid medium. This method produces rare earth carbonates having a chloride-ion content of less than 50 ppm and a small particle size, but requires special equipment.

CN115849429A discloses a method of preparing lanthanum carbonate tetrahydrate. The method comprises: reacting an excessive amount of hydrochloric acid with lanthanum oxide to prepare a mixed solution of hydrochloric acid and lanthanum chloride; transferring the mixed solution to a sealable reaction vessel; slowly adding a sodium bicarbonate solution to the reaction vessel, while controlling the discharge of carbon dioxide generated by the neutralization reaction such that the pressure in the reaction vessel is controlled at a positive pressure of 100-1000 Pa and that the reaction proceeds in a positive-pressure environment rich in carbon dioxide; filtering the system and washing the solid with water after the reaction is completed, giving the wet product of lanthanum carbonate octahydrate; and drying the wet product of lanthanum carbonate octahydrate to obtain lanthanum carbonate tetrahydrate. The product of lanthanum carbonate tetrahydrate does not have a low chloride-ion content and has D₅₀ of 6-10 μm, not a small particle size.

How to process a rare earth carbonate obtained by being precipitated from a rare earth solution that contains anions (e.g., Cl⁻, SO₄²⁻, and NO₃⁻) in a high content (e.g., 100 ppm or more) and has a large particle size with a view to decreasing the content of anions while making the particle size smaller is an urgent technical problem to be solved.

CN103708525A discloses a method of producing rare earth carbonates and oxides having a low chloride-ion content. The method comprises placing a rare earth carbonate in a hot alkaline aqueous solution with a pH of 7 or greater and at a temperature of 80° C. or higher, and letting the reaction proceed for 30 minutes or more, wherein the rare earth carbonate and the alkaline aqueous solution are at a liquid-solid ratio of 1:1 to 50:1, and the mole ratio of the alkali to the rare earth is 0.5:1 to 1.1:1. The rare earth hydroxycarbonate produced by the method does not have a small particle size and not contain chloride ions in a low content.

### SUMMARY OF THE DISCLOSURE

In view of the above, it is one objective of the present disclosure to provide a method of increasing the rate of phase conversion. The method can significantly improve the rate of phase conversion from a rare earth carbonate to a rare earth hydroxycarbonate and considerably reduce the content of impurities such as Cl⁻, SO₄²⁻, and NO₃⁻. It is another objective of the present disclosure to provide a method of preparing a rare earth hydroxycarbonate from a rare earth carbonate.

It is still another objective of the present disclosure to provide use of a carboxylate-containing substance.

The present disclosure accomplishes the above objectives by technical solutions described below.

One aspect of the present disclosure is to provide a method of increasing the rate of phase conversion in the course of preparing a rare earth hydroxycarbonate from a rare earth carbonate, comprising:
mixing a rare earth carbonate with an aqueous solution of a carboxylate-containing substance to obtain a slurry; and
heating the slurry such that reactions proceed.

Another aspect of the present disclosure is to provide a method of preparing a rare earth hydroxycarbonate from a rare earth carbonate, comprising:
mixing a rare earth carbonate with an aqueous solution of a carboxylate-containing substance to obtain a slurry;
heating the slurry such that reactions proceed to obtain an intermediate product; and
converting the intermediate product into crystals of a rare earth hydroxycarbonate, clusters of a rare earth hydroxycarbonate, or a mixture of crystals of a rare earth hydroxycarbonate and clusters of a rare earth hydroxycarbonate.

In the method according to the present disclosure, the carboxylate-containing substance is preferably selected from:
(1) a C1-C6 monocarboxylic acid, or
(2) a mixture of a C1-C6 monocarboxylic acid and an ammonium salt of a C1-C6 monocarboxylic acid.

In the method according to the present disclosure,
the C1-C6 monocarboxylic acid is selected from one or more of formic acid, acetic acid and propionic acid, and
the mixture of a C1-C6 monocarboxylic acid and an ammonium salt of a C1-C6 monocarboxylic acid is preferably selected from a mixture of formic acid and ammonium formate, a mixture of acetic acid and ammonium acetate, or a mixture of propionic acid and ammonium propionate.

In the method according to the present disclosure,
the amount of the carboxylatel-containing substance is 1-9% of the theoretical number of moles of the carboxylate-containing substance that is needed for the complexation reaction between the carboxylate-containing substance and the rare earth element in the rare earth carbonate; and
the concentration of the carboxylate-containing substance in the aqueous solution thereof is 0.015 to 0.15 mol/L.

In the method according to the present disclosure, heating the slurry such that reactions proceed is preferably heating the slurry to a temperature of 50-100° C. such that reactions proceed for 10-600 min.

The method according to the present disclosure preferably further comprises:
performing solid-liquid separation after converting the intermediate product into crystals of a rare earth hydroxycarbonate, clusters of a rare earth hydroxycarbonate, or a mixture of crystals of a rare earth hydroxycarbonate and clusters of a rare earth hydroxycarbonate, and recycling the resulting liquid as an aqueous solution of a carboxylate-containing substance.

In the method according to the present disclosure,
the rare earth carbonate contains Cl⁻, SO₄²⁻, and NO₃⁻ in a total content of greater than 120 ppm, and the rare earth hydroxycarbonate contains Cl⁻, SO₄²⁻, and NO₃⁻ in a total content of 50 ppm or less; and
the rare earth hydroxycarbonate has an average particle diameter D₅₀ of less than 5.5 μm.

Another aspect of the present disclosure is to provide use of a carboxylate-containing substance in increasing the rate of phase conversion in the course of preparing a rare earth hydroxycarbonate from a rare earth carbonate.

In the use according to the present disclosure, the carboxylate-containing substance is preferably selected from:
(1) a C1-C6 monocarboxylic acid, or
(2) a mixture of a C1-C6 monocarboxylic acid and an ammonium salt of a C1-C6 monocarboxylic acid.

The method of the present disclosure can improve the rate of phase conversion from a rare earth carbonate to a rare earth hydroxycarbonate. The present disclosure can convert a rare earth carbonate containing anions (e.g., Cl⁻, SO₄²⁻, and NO₃⁻) in a high content and having a large particle diameter into a rare earth hydroxycarbonate containing the anions in a low content and having a small particle diameter. The total content of anions can be decreased from 200 ppm or more to 50 ppm or less. The present disclosure uses a small amount of a carboxylate-containing substance and can recycle it, so it costs less and is more environmentally friendly. The method of the present disclosure, compared with traditional hydrothermal conversion methods—which consume much energy, is advantageous in that it is quick, consumes less energy, comprises simple procedures, and is easy to be industrialized. Furthermore, the method of the present disclosure comprises controllable procedures and can convert a rare earth carbonate into crystals of a rare earth hydroxycarbonate, clusters of a rare earth hydroxycarbonate, or a mixture of crystals of a rare earth hydroxycarbonate and clusters of a rare earth hydroxycarbonate.

### BRIEF SUMMARY OF THE DRAWINGS

FIG. 1 is a scanning electron microscope (SEM) image of lanthanum hydroxycarbonate obtained in Example 1 of the present disclosure.

FIG. 2 is an X-ray diffraction (XRD) pattern of lanthanum hydroxycarbonate obtained in Example 1 of the present disclosure.

FIG. 3 is an XRD pattern of cerium hydroxycarbonate obtained in Example 2 of the present disclosure.

FIG. 4 is an XRD pattern of cerium carbonate octahydrate as the raw material in Example 2 of the present disclosure.

FIG. 5 is an SEM image of neodymium-praseodymium hydroxycarbonate obtained in Example 3 of the present disclosure.

FIG. 6 is an XRD pattern of europium hycroxycarbonate obtained in Example 6 of the present disclosure.

FIG. 7 is an SEM image of europium hycroxycarbonate obtained in Example 6 of the present disclosure.

FIG. 8 is an SEM image of the product obtained in Comparative Example 1.

FIG. 9 is XRD patterns of the intermediate product and product of Comparative Example 1.

FIG. 10 is an SEM image of the product obtained in Comparative Example 2.

FIG. 11 is XRD patterns of the intermediate product and product of Comparative Example 2.

### DETAIL DESCRIPTION OF THE DISCLOSURE

The following is a further description of the present disclosure by means of embodiments, but the present disclosure is not limited to those embodiments.

In the present disclosure, Cm-Cn means having m to n carbon atoms. For example, a C1-C6 monocarboxylic acid denotes a monocarboxylic acid having 1 to 6 carbon atoms.

In the present disclosure, D₅₀ is known as a median diameter or a medium value of particle size distribution, and it is the value of the particle diameter at 50% in the cumulative distribution of a sample. It means that 50% of the particles in the sample are larger than it, and 50% smaller than it.

The present disclosure provides a method of increasing the rate of phase conversion in the course of preparing a rare earth hydroxycarbonate from a rare earth carbonate, which comprises: 1) a mixing step; and 2) a reacting step. Preferably, the method further comprises a converting step. The present disclosure provides a method of preparing a rare earth hydroxycarbonate from a rare earth carbonate, which comprises: 1) a mixing step; 2) a reacting step; and 3) a converting step. There is hereinafter a detailed description of the steps.

### <Mixing Step>

A slurry is obtained by mixing a rare earth carbonate with an aqueous solution of a carboxylate-containing substance. Doing so helps to increase the rate of phase conversion. Also, doing so helps to obtain a rare earth hydroxycarbonate having a small particle size while reducing the content of anions.

In the present disclosure, the rare earth element RE in the rare earth carbonate can be one or more of La to Gd arranged in an ascending order of atomic numbers. The rare earth element RE includes lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), and yttrium (Y). Preferably, the rare earth element RE is lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), and yttrium (Y). Preferably, the rare earth element RE is one or more selected from lanthanum (La), cerium (Ce), praseodymium (Pr), neodymium (Nd), samarium (Sm), europium (Eu), and gadolinium (Gd). Still more preferably, the rare earth element RE is selected from one or more of lanthanum (La), cerium (Ce), and samarium (Sm). This helps to obtain nanocrystals of a rare earth hydroxycarbonate and reduce the particle size of a rare earth hydroxycarbonate. More preferably, the rare earth element RE is lanthanum (La). This helps to obtain a nano-sized rare earth hydroxycarbonate.

The rare earth carbonate contains Cl⁻, SO₄²⁻, and NO₃⁻ in a total content of greater than 120 ppm, preferably greater than 150 ppm, and more preferably greater than 200 ppm. The rare earth carbonate has a D₅₀ of 45 μm or more. Such a rare earth carbonate, after being treated by the method of the present disclosure, makes it possible to obtain a rare earth hydroxycarbonate having a small particle diameter and containing Cl⁻, SO₄²⁻, and NO₃⁻ in a total content of 50 ppm or less.

In the present disclosure, the rare earth carbonate can be a solid powder of a rare earth carbonate that does not contain water of crystallization, or can be a rare earth carbonate containing water of crystallization. Most of rare earth carbonates contain water of crystallization.

In the present disclosure, the carboxylate-containing substance in an aqueous solution of a carboxylate-containing substance is selected from:
(1) a C1-C6 monocarboxylic acid, or
(2) a mixture of a C1-C6 monocarboxylic acid and an ammonium salt of a C1-C6 monocarboxylic acid.

In some embodiments, the carboxylate-containing substance is selected from a C1-C6 monocarboxylic acid. In other embodiments, the carboxylate-containing substance is selected from a mixture of a C1-C6 monocarboxylic acid and an ammonium salt of a C1-C6 monocarboxylic acid.

Examples of the C1-C6 monocarboxylic acid include, but are not limited to, formic acid, acetic acid, propionic acid, n-butyric acid, isobutyric acid, n-valeric acid, and n-hexanoic acid. In some specific embodiments, the carboxylate-containing material is selected from one or more of formic acid, acetic acid, propionic acid, and n-butyric acid. Preferably, the carboxylate-containing substance is acetic acid. This helps to obtain a nano-sized rare earth hydroxycarbonate.

In other specific embodiments, the carboxylate-containing substance is selected from one or more of a mixture of formic acid and ammonium formate, a mixture of acetic acid and ammonium acetate, a mixture of propionic acid and ammonium propionate, and a mixture of n-butyric acid and ammonium n-butyrate. Preferably, the carboxylate-containing substance is a mixture of acetic acid and ammonium acetate. This helps to obtain nanocrystals of a rare earth hydroxycarbonate and reduce the particle size of a rare earth hydroxycarbonate.

In the present disclosure, there is no particular limitation on the ratio between the amount of a C1-C6 monocarboxylic acid and a corresponding ammonium salt thereof, and it can be, for example, 10-1:1. Specifically, it can be 10:1, 9:1, 8:1, 7:1, 6:1, 5:1, 4:1, 3:1, 2:1, or 1:1.

As has been discovered by the present disclosure, a rare earth carbonate, once in a high-temperature aqueous solution, is hydrolyzed; RE³⁺ combines with H₂O and exists in the form of [RE(OH)(H₂O)ₙ₋₁]²⁺; and [RE(OH)(H₂O)ₙ₋₁]²⁺, when colliding with CO₃²⁻ ions, reacts with them and becomes RECO₃OH.

A carboxylate-containing substance, when added to the reaction system, first reacts with the rare earth carbonate. Raising the temperature of the system can also promote the ionization of the carboxylic acid and thereby allow more H⁺ ions to be released. This speeds up the dissolution of the rare earth carbonate, and CO₂ is released in the reaction. The released CO₂ is dissolved in water, and the generated carbonic acid creates CO₃²⁻ and H⁺, which make the rare earth carbonate dissolve faster and thereby lead to the generation of more RE³⁺ and CO₃²⁻ ions. When CO₃²⁻ ions collide with [RE(OH)(H₂O)ₙ₋₁]²⁺, they react with each other, generating RECO₃OH. This helps to increase the rate of phase conversion from a rare earth carbonate to a rare earth hydroxycarbonate.

Reactions shown by Equations (1)-(5) are assumed to occur in the system, though the principle is not yet clear.

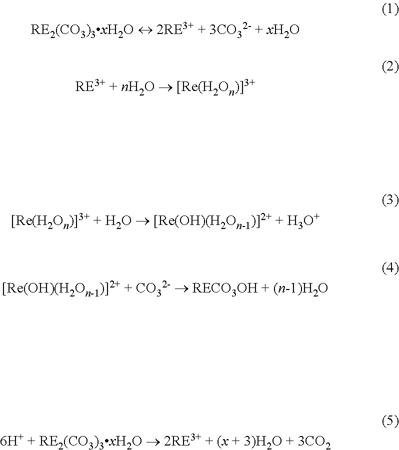

The present disclosure can increase the rate of phase conversion of a rare earth carbonate using an aqueous solution of a carboxylate-containing substance by 50-200%, compared with using pure water under the same conditions. The present disclosure makes it possible to release impurities (particularly, impurities such as Cl⁻, SO₄²⁻, and NO₃⁻) wrapped or confined in a rare earth carbonate by dramatically changing the morphology and particle size of the rare earth carbonate and thereby achieves the effect of impurity reduction.

As has also been discovered by the present disclosure, acetic acid can also act as a dispersant and effectively inhibit the agglomeration of a rare earth hydroxycarbonate.

In the present disclosure, the aqueous solution of a carboxylate-containing substance can be in a concentration of 0.015-0.15 mol/L, preferably 0.03-0.15 mol/L, and more preferably 0.05-0.135 mol/L. The amount of the carboxylatel-containing substance in the aqueous solution of the carboxylate-containing substance is 1-9%, preferably 2-9%, and more preferably 3-8% of the theoretical number of moles of the carboxylate-containing substance that is needed for the complexation reaction between the carboxylate-containing substance and the rare earth element in a rare earth carbonate. The present disclosure mixes the solid of a rare earth carbonate with an aqueous solution of a carboxylate-containing substance to obtain a slurry. This helps to increase the rate of phase conversion, obtain a rare earth hydroxycarbonate having a small particle size, and reduce the content of anions.

### <Reacting Step and Converting Step>

An intermediate product is obtained by heating the slurry to allow reactions to proceed. This helps to increase the rate of phase conversion. The intermediate product is converted, by being heated, into crystals of a rare earth hydroxycarbonate, clusters of a rare earth hydroxycarbonate, or a mixture of crystals of a rare earth hydroxycarbonate and clusters of a rare earth hydroxycarbonate.

The reacting step and the converting step can be carried out at a temperature of 50-100° C., preferably 60-95° C., and more preferably 70-90° C. The reacting step and the converting step can be carried out for a total duration of 10-600 minutes, preferably 20-300 minutes, and more preferably 30-200 minutes. In some embodiments, the reacting step can be carried out for a duration of 10-90 minutes, preferably 20-80 minutes, and more preferably from 30-60 minutes. The converting step can be carried out for a duration of 50-300 minutes, preferably 60-200 minutes, and more preferably 70-100 minutes.

Stirring is required in the reacting and converting steps. The stirring can be carried out at a speed of 150-1000 rpm, preferably 200-800 rpm, more preferably 250-700 rpm, and even more preferably 300-600 rpm. This helps to improve the rate of phase conversion, obtain a rare earth hydroxycarbonate having a small particle size, and reduce the content of impurities such as Cl⁻, SO₄²⁻, and NO₃⁻.

Converting the intermediate product into crystals of a rare earth hydroxycarbonate, clusters of a rare earth hydroxycarbonate, or a mixture of crystals of a rare earth hydroxycarbonate and clusters of a rare earth hydroxycarbonate is followed by solid-liquid separation, and the resulting liquid is recycled as an aqueous solution of a carboxylate-containing substance. This makes it possible to obtain not only a rare earth hydroxycarbonate but also a liquid that can be recycled and reduces liquid waste.

The solid-liquid separation can be centrifugation or filtration, and preferably filtration. Filtration gives a filter cake and a filtrate. The filtrate can be recycled as an aqueous solution of a carboxylate-containing substance, which can be supplemented with a carboxylate-containing substance as needed. The solid from the solid-liquid separation can be washed with water and dried, resulting in the product of a rare earth hydroxycarbonate. The product of a rare earth hydroxycarbonate can be crystals of a rare earth hydroxycarbonate, clusters of a rare earth hydroxycarbonate, or a mixture of crystals of a rare earth hydroxycarbonate and clusters of a rare earth hydroxycarbonate.

The rare earth hydroxycarbonate prepared by the method of the present disclosure contains Cl⁻, SO₄²⁻, and NO₃⁻ in a total content of 50 ppm or less, and it has an average particle diameter D₅₀ of less than 5.5 μm and preferably 5 μm or less.

According to one embodiment of the present disclosure, the method of preparing a rare earth hydroxycarbonate from a rare earth carbonate comprises the following steps:

providing a rare earth carbonate containing Cl⁻, SO₄²⁻, and NO₃⁻ in a total content of greater than 200 ppm and having an average particle diameter D₅₀ of 45 μm or more;
preparing an aqueous solution of a carboxylate-containing substance that contains the carboxylate-containing substance in a molarity of 0.015-0.15 mol/L;
mixing the rare earth carbonate with the aqueous solution of a carboxylate-containing substance (the amount of the carboxylate-containing substance being 1-9% of the theoretical number of moles of the carboxylate-containing substance that is needed for the complexation reaction between the carboxylate-containing substance and the rare earth element in the rare earth carbonate) to obtain a slurry; heating the slurry to a temperature of 70-100° C., and letting reactions proceed at a temperature of 70-100° C. for 10-90 minutes while stirring the slurry at a speed of 150-500 rpm to obtain an intermediate product; converting the intermediate product a temperature of 70-100° C. for 50-300 min while stirring the system at a speed of 150-500 rpm; filtering the system to obtain a filter cake and a filtrate; keeping the filtrate for recycle; washing the filter cake with water; drying the washed filter cake; and milling the dried filter cake to obtain a rare earth hydroxycarbonate containing Cl⁻, SO₄²⁻, and NO₃⁻ in a total content of 50 ppm or less and having an average particle diameter D₅₀ of 5 μm or less. The resulting rare earth hydroxycarbonate is crystals of a rare earth hydroxycarbonate, clusters of a rare earth hydroxycarbonate, or a mixture of crystals of a rare earth hydroxycarbonate and clusters of a rare earth hydroxycarbonate.

### <Use of Carboxylate-Containing Substance>

As the present disclosure has discovered, an aqueous solution of a carboxylate-containing substance in the present disclosure can first react with part of a rare earth carbonate and generates a rare earth complex, the rare earth element in the rare earth complex exists in the solution in an ionic state; the carboxylate-containing substance promotes the hydrolysis of the rare earth carbonate, and more carbonate anions and rare earth ions can directly participate in the generation of a rare earth hydroxycarbonate, which increases the rate of phase conversion of the rare earth carbonate. Compared with pure water, an aqueous solution of a carboxylate-containing substance can increase the rate of phase conversion by 50-200% under the same conditions. The term “phase conversion” herein means the conversion from a rare earth carbonate in one form to a rare earth hydroxycarbonate in another form. As the present disclosure has discovered, in the process described above, a sphere-like rare earth carbonate having a large particle size is gradually broken and transformed into a spindle-like rare earth hydroxycarbonate having a small particle size that exists in one or more forms of nanoclusters and nanocrystalline grains; and impurities (e.g., Cl⁻, SO₄²⁻, and NO₃⁻) wrapped or confined in a rare earth carbonate is released, and the content of those impurities is reduced.

Accordingly, the present disclosure also provides use of a carboxylate-containing substance in increasing the rate of phase conversion in the course of preparing a rare earth hydroxycarbonate from a rare earth carbonate. The use comprises: 1) a mixing step; and 2) a reacting step. Preferably, the use further comprises: 3) a converting step. The details of the steps and the selection of the substance have been described hereinbefore and are not repeated here.

The following is a description of methods for testing:

The content of chloride ions was determined by the spectrophotometric mercury thiocyanate-iron method in T6 New Century UV-Visible Spectrophotometer.

The contents of sulfate and nitrate ions were determined by inductively coupled plasma mass spectrometry in Agilent 5800 ICP-OES.

SEM characterization was carried out in Sigma-500 Field Emission Scanning Electron Microscope.

XRD Characterization was carried out in D8 ADVANCE, an X-ray diffractometer (XRD) from Bruker, Germany.

Particle size distribution was determined by a wet dispersion method in Bettersize 2600, a Bettersize laser particle size analyzer.

### Example 1

Provide 500 g of a lanthanum carbonate solid containing Cl⁻ in a content of 360 ppm and having an average particle diameter D₅₀ of 65 μm;
prepare an acetic acid solution (an aqueous solution of a carboxylate-containing substance) that contained acetic acid in a molarity of 0.125 mol/L;
mix the lanthanum carbonate solid with the acetic acid solution (the amount of acetic acid being 7% of the theoretical number of moles of acetic acid that is needed for the complexation reaction between acetic acid and the element lanthanum in lanthanum carbonate) to obtain a slurry; heat the slurry to a temperature of 70° C., let reactions proceed at a temperature of 70° C. for 60 minutes while stirring the slurry at a speed of 300 rpm to obtain nanoclusters of lanthanum hycroxycarbonate, and continue the reactions until a total of 120 minutes elapsed to obtain nanocrystalline grains of lanthanum hycroxycarbonate; filter the system to obtain a filter cake and a filtrate; keep the filtrate for recycle; wash the filter cake with water; dry the washed filter cake at 60° C. for 4 hr; and mill the dried filter cake to obtain lanthanum hycroxycarbonate. The resulting lanthanum hycroxycarbonate was nanocrystalline grains of lanthanum hycroxycarbonate that had an average particle diameter D₅₀ of 0.087 μm and contained Cl⁻ in a content of 45 ppm.

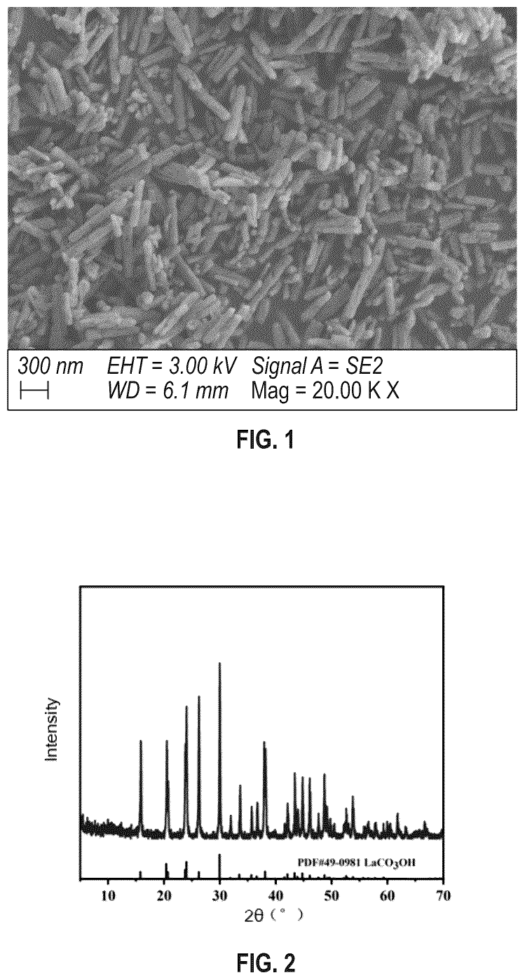

FIG. 1 shows an SEM image of lanthanum hydroxycarbonate obtained in Example 1, and FIG. 2 shows its XRD pattern.

### Example 2

Provide 500 g of a cerium carbonate solid (cerium carbonate octahydrate) containing Cl⁻ in a content of 320 ppm and having an average particle diameter D₅₀ of 59 μm;
prepare a mixture solution of acetic acid and ammonium acetate (an aqueous solution of a carboxylate-containing substance) that contained acetic acid in a molarity of 0.05 mol/L and ammonium acetate in a molarity of 0.01 mol/L;
mix the cerium carbonate solid with the mixture solution of acetic acid and ammonium acetate (the amount of acetic acid being 5% of the theoretical number of moles of acetic acid that is needed for the complexation reaction between acetic acid and the element cerium in cerium carbonate, and the amount of ammonium acetate being 1% of the theoretical number of moles of ammonium acetate that is needed for the complexation reaction between ammonium acetate and the element cerium in cerium carbonate) to obtain a slurry; heat the slurry to a temperature of 80° C., let reactions proceed at a temperature of 80° C. for 20 minutes while stirring the slurry at a speed of 300 rpm to obtain cerium carbonate tetrahydrate, continue the reactions until a total of 60 minutes elapsed to obtain nanoclusters of cerium hydroxycarbonate, and continue the reactions until a total of 120 minutes elapsed to obtain nanocrystalline grains of cerium hydroxycarbonate; filter the system to obtain a filter cake and a filtrate; keep the filtrate for recycle; wash the filter cake with water; dry the washed filter cake at 60° C. for 4 hr; and mill the dried filter cake to obtain cerium hydroxycarbonate. The resulting cerium hycroxycarbonate was nanocrystalline grains of cerium hydroxycarbonate that had an average particle diameter D₅₀ of 0.32 μm and contained Cl⁻ in a content of 25 ppm.

FIG. 3 shows an SEM image of cerium hydroxycarbonate obtained in Example 2, and FIG. 4 shows an XRD pattern of cerium carbonate octahydrate as the raw material in Example 2.

### Example 3

Provide 500 g of a neodymium-praseodymium carbonate solid containing SO₄²⁻ in a content of 320 ppm and having an average particle diameter D₅₀ of 54 μm;
prepare a mixture solution of propionic acid and ammonium propionate (an aqueous solution of a carboxylate-containing substance) that contained propionic acid in a molarity of 0.03 mol/L and ammonium propionate in a molarity of 0.01 mol/L;
mix the neodymium-praseodymium carbonate solid with the mixture solution of propionic acid and ammonium propionate (the amount of propionic acid being 3% of the theoretical number of moles of propionic acid that is needed for the complexation reaction between propionic acid and the elements neodymium and praseodymium in neodymium-praseodymium carbonate, and the amount of ammonium propionate being 1% of the theoretical number of moles of ammonium propionate that is needed for the complexation reaction between ammonium propionate and the elements neodymium and praseodymium in neodymium-praseodymium carbonate) to obtain a slurry; heat the slurry to a temperature of 90° C., and let reactions proceed at a temperature of 90° C. for 160 minutes while stirring the slurry at a speed of 300 rpm to obtain nanoclusters of neodymium-praseodymium hydroxycarbonate; filter the system to obtain a filter cake and a filtrate; keep the filtrate for recycle; wash the filter cake with water; dry the washed filter cake at 60° C. for 4 hr; and mill the dried filter cake to obtain neodymium-praseodymium hydroxycarbonate. The resulting neodymium-praseodymium hycroxycarbonate was nanoclusters of neodymium-praseodymium hycroxycarbonate that had an average particle diameter D₅₀ of 0.64 μm and contained SO₄²⁻ in a content of 40 ppm.

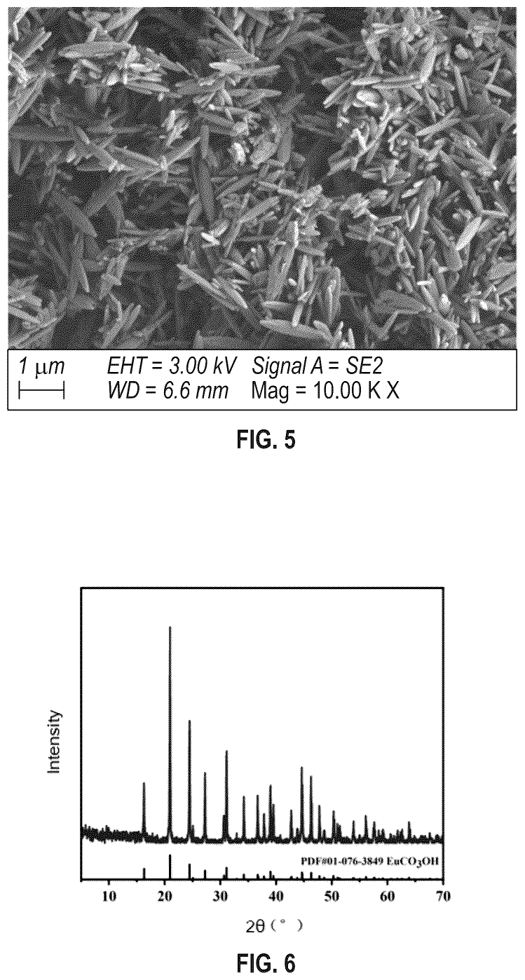

FIG. 5 shows an SEM image of neodymium-praseodymium hydroxycarbonate obtained in Example 3.

### Example 4

Provide 250 g of a lanthanum carbonate solid containing Cl⁻ in a content of 360 ppm and having an average particle diameter D₅₀ of 65 μm, and 250 g of a cerium carbonate solid containing Cl⁻ in a content of 320 ppm and having an average particle diameter D₅₀ of 59 μm;
prepare a propionic acid solution (an aqueous solution of a carboxylate-containing substance) that contained propionic acid in a molarity of 0.09 mol/L;
mix the lanthanum carbonate solid and the cerium carbonate solid with the propionic acid solution (the amount of propionic acid being 9% of the theoretical number of moles of propionic acid that is needed for the complexation reaction between propionic acid and the elements lanthanum and cerium in lanthanum carbonate and cerium carbonate) to obtain a slurry; heat the slurry to a temperature of 90° C., and let reactions proceed at a temperature of 90° C. for 160 minutes while stirring the slurry at a speed of 300 rpm to obtain nanoclusters of lanthanum-cerium hydroxycarbonate; filter the system to obtain a filter cake and a filtrate; keep the filtrate for recycle; wash the filter cake with water; dry the washed filter cake at 60° C. for 4 hr; and mill the dried filter cake to obtain lanthanum-cerium hycroxycarbonate. The resulting lanthanum-cerium hycroxycarbonate was nanoclusters of lanthanum-cerium hycroxycarbonate that had an average particle diameter D₅₀ of 2.64 μm and contained SO₄²⁻ in a content of 40 ppm.

### Example 5

Provide 500 g of a samarium carbonate solid containing NO₃⁻ in a content of 290 ppm and having an average particle diameter D₅₀ of 45 μm;
prepare a formic acid solution (an aqueous solution of a carboxylate-containing substance) that contained formic acid in a molarity of 0.05 mol/L;
mix the samarium carbonate solid with the formic acid solution (the amount of formic acid being 9% of the theoretical number of moles of formic acid that is needed for the complexation reaction between formic acid and the element samarium in samarium carbonate) to obtain a slurry; heat the slurry to a temperature of 100° C., and let reactions proceed at a temperature of 100° C. for 300 minutes while stirring the slurry at a speed of 300 rpm to obtain nanoclusters of samarium hycroxycarbonate; filter the system to obtain a filter cake and a filtrate; keep the filtrate for recycle; wash the filter cake with water; dry the washed filter cake at 60° C. for 4 hr; and mill the dried filter cake to obtain samarium hycroxycarbonate. The resulting samarium hycroxycarbonate was nanoclusters of samarium hycroxycarbonate that had an average particle diameter D₅₀ of 3.4 μm and contained NO₃⁻ in a content of 35 ppm.

### Example 6

Provide 500 g of a europium carbonate solid containing NO₃⁻ in a content of 240 ppm and having an average particle diameter D₅₀ of 53 μm;
prepare a mixed solution of formic acid, acetic acid and propionic acid (an aqueous solution of a carboxylate-containing substance) that contained formic acid, acetic acid and propionic acid each in a molarity of 0.01 mol/L;
mix the europium carbonate solid with the mixed solution of formic acid, acetic acid and propionic acid (the amount of formic acid being 3% of the theoretical number of moles of formic acid that is needed for the complexation reaction between formic acid and the element europium in europium carbonate, the amount of acetic acid being 3% of the theoretical number of moles of acetic acid that is needed for the complexation reaction between acetic acid and the element europium in europium carbonate, and the amount of propionic acid being 3% of the theoretical number of moles of propionic acid that is needed for the complexation reaction between propionic acid and the element europium in europium carbonate) to obtain a slurry; heat the slurry to a temperature of 95° C., and let reactions proceed at a temperature of 95° C. for 400 minutes while stirring the slurry at a speed of 300 rpm to obtain nanoclusters of europium hycroxycarbonate; filter the system to obtain a filter cake and a filtrate; keep the filtrate for recycle; wash the filter cake with water; dry the washed filter cake at 60° C. for 4 hr; and mill the dried filter cake to obtain europium hycroxycarbonate. The resulting europium hycroxycarbonate was nanoclusters of samarium hycroxycarbonate that had an average particle diameter D₅₀ of 4.2 μm and contain NO₃⁻ in a content of less than 50 ppm.

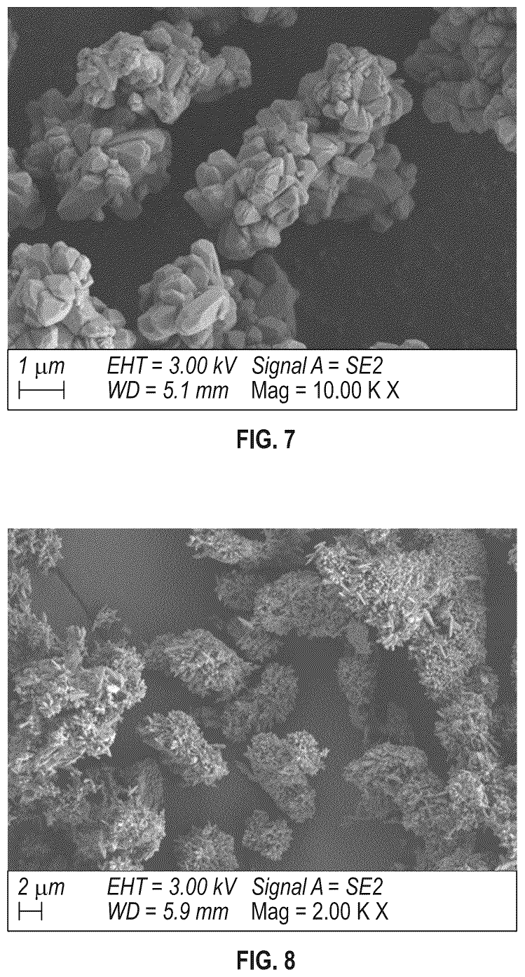

FIG. 6 shows an XRD pattern of europium hycroxycarbonate obtained in Example 6, and FIG. 7 shows an SEM image of europium hycroxycarbonate obtained in Example 6.

### Example 7

Provide 500 g of a gadolinium carbonate solid containing Cl⁻ in a content of 280 ppm and having an average particle diameter D₅₀ of 56 μm;
prepare a mixture solution of formic acid, ammonium formate, acetic acid, and ammonium acetate (an aqueous solution of a carboxylate-containing substance) that contained formic acid in a molarity of 0.05 mol/L, ammonium formate in a molarity of 0.05 mol/L, acetic acid in a molarity of 0.03 mol/L, and ammonium acetate in a molarity of 0.03 mol/L;
mix the gadolinium carbonate solid with the aqueous solution of a carboxylate-containing substance (the sum of the number of moles of formic acid and that of ammonium formate being 5% of the theoretical number of moles of formic acid that is needed for the complexation reaction between formic acid and the element gadolinium in gadolinium carbonate, and the ratio of the number of moles of formic acid to that of ammonium formate being 5:1; the sum of the number of moles of acetic acid and that of ammonium acetate being 3% of the theoretical number of moles of acetic acid that is needed for the complexation reaction between acetic acid and the element gadolinium in gadolinium carbonate, and the ratio of the number of moles of acetic acid to that of ammonium acetate being 5:1) to obtain a slurry; heat the slurry to a temperature of 95° C., and let reactions proceed at a temperature of 95° C. for 600 minutes while stirring the slurry at a speed of 300 rpm to obtain a mixture of nanoclusters of gadolinium hycroxycarbonate and nanocrystalline grains of gadolinium hycroxycarbonate; filter the system to obtain a filter cake and a filtrate; keep the filtrate for recycle; wash the filter cake with water; dry the washed filter cake at 60° C. for 4 hr; and mill the dried filter cake to obtain europium hycroxycarbonate. The resulting gadolinium hycroxycarbonate was a mixture of nanoclusters of gadolinium hycroxycarbonate and nanocrystalline grains of gadolinium hycroxycarbonate that had an average particle diameter D₅₀ of 4.6 μm and contained Cl⁻ in a content of 42 ppm.

### Example 8

Provide 200 g of a cerium carbonate solid containing Cl⁻ in a content of 320 ppm and having an average particle diameter D₅₀ of 59 μm, and 300 g of a samarium carbonate solid containing NO₃⁻ in a content of 290 ppm and having an average particle diameter D₅₀ of 45 μm;
prepare a mixture solution of propionic acid, ammonium propionate, acetic acid, and ammonium acetate (an aqueous solution of a carboxylate-containing substance) that contained propionic acid in a molarity of 0.15 mol/L, ammonium propionate in a molarity of 0.15 mol/L, acetic acid in a molarity of 0.015 mol/L, and ammonium acetate in a molarity of 0.015 mol/L;
mix the cerium carbonate solid and the samarium carbonate solid with the aqueous solution of a carboxylate-containing substance (the sum of the number of moles of propionic acid and that of ammonium propionate being 9% of the theoretical number of moles of propionic acid that is needed for the complexation reaction between propionic acid and the elements cerium and samarium in cerium carbonate and samarium carbonate, and the ratio of the number of moles of propionic acid to that of ammonium propionate being 3:1; the sum of the number of moles of acetic acid and that of ammonium acetate being 1% of the theoretical number of moles of acetic acid that is needed for the complexation reaction between acetic acid and the elements cerium and samarium in cerium carbonate and samarium carbonate, and the ratio of the number of moles of acetic acid to that of ammonium acetate being 3:1) to obtain a slurry; heat the slurry to a temperature of 90° C., and let reactions proceed at a temperature of 90° C. for 450 minutes while stirring the slurry at a speed of 300 rpm to obtain nanocrystalline grains of cerium-samarium hycroxycarbonate; filter the system to obtain a filter cake and a filtrate; keep the filtrate for recycle; wash the filter cake with water; dry the washed filter cake at 60° C. for 4 hr; and mill the dried filter cake to obtain cerium-samarium hycroxycarbonate. The resulting cerium-samarium hycroxycarbonate was nanocrystalline grains of cerium-samarium hycroxycarbonate that had an average particle diameter D₅₀ of 0.64 μm and contain Cl⁻ and NO₃⁻ in a total content of 50 ppm.

### Comparative Example 1

This comparative example differed from Example 2 in that there was not an aqueous solution of a carboxylate-containing substance.

To be specific, mix the cerium carbonate solid with pure water to obtain a slurry; heat the slurry to a temperature of 80° C., let reactions proceed at a temperature of 80° C. for 20 minutes while stirring the slurry at a speed of 300 rpm—which did not lead to conversion of cerium carbonate, continue the reactions until a total of 120 minutes elapsed to obtain a mixture of cerium carbonate and cerium hydroxycarbonate, and continue the reactions until a total of 180 minutes elapsed to obtain micron clusters of cerium hydroxycarbonate; filter the system to obtain a filter cake and a filtrate; keep the filtrate for recycle; wash the filter cake with water; and dry the washed filter cake at 60° C. for 4 hr to obtain cerium hydroxycarbonate having an average particle diameter D₅₀ of 12.54 μm and containing Cl⁻ in a content of 85 ppm.

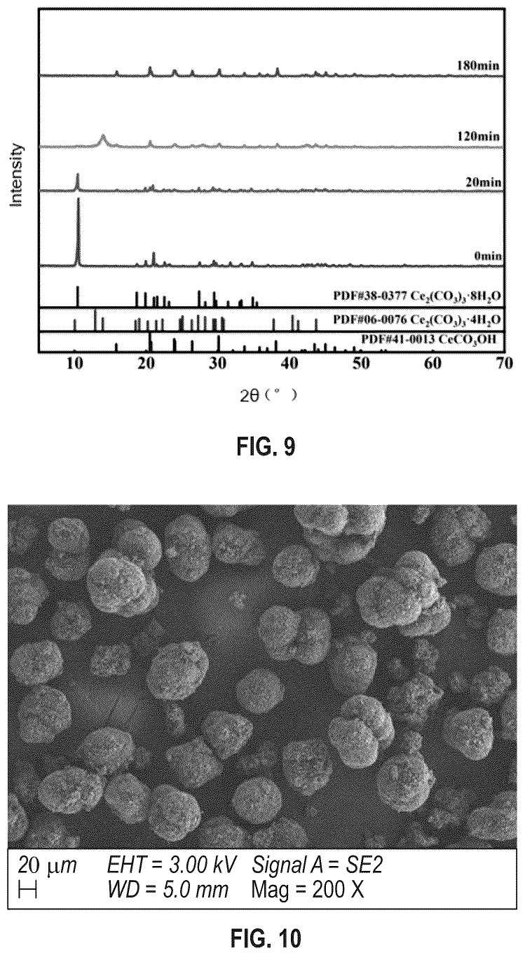

FIG. 8 shows an SEM image of cerium hydroxycarbonate obtained in Comparative Example 1, and FIG. 9 shows XRD patterns of the raw material, intermediate product, and product of Comparative Example 1.

### Comparative Example 2

This comparative example differed from Example 6 in that there was not an aqueous solution of a carboxylate-containing substance.

To be specific, mix the europium carbonate solid with pure water to obtain a slurry; heat the slurry to a temperature of 95° C., let reactions proceed at a temperature of 95° C. for 400 minutes while stirring the slurry at a speed of 300 rpm—which did not lead to complete conversion of europium carbonate but resulted in a mixture of europium carbonate and europium hydroxycarbonate; filter the system to obtain a filter cake and a filtrate; keep the filtrate for recycle; wash the filter cake with water; and dry the washed filter cake at 60° C. for 4 hr to obtain a mixture of europium carbonate and europium hydroxycarbonate that was micron spheres having an average particle diameter D₅₀ of 46 μm and containing NO₃⁻ in a content of 215 ppm.

FIG. 10 shows an SEM image of the product obtained in Comparative Example 2, and FIG. 11 shows XRD patterns of the intermediate product and product of Comparative Example 2.

The present disclosure is not limited to the embodiments described above. Any variation, improvement, and replacement which do not depart from the essence of the present disclosure and which those skilled in the art are able to think of fall within the scope of the present disclosure.

What is claimed is:

1. A method of increasing the rate of phase conversion in the course of preparing a rare earth hydroxycarbonate from a rare earth carbonate, comprising:
mixing the rare earth carbonate with an aqueous solution of a carboxylate-containing substance to obtain a slurry; and
heating the slurry such that reactions proceed.

2. A method of preparing a rare earth hydroxycarbonate from a rare earth carbonate, comprising:
mixing the rare earth carbonate with an aqueous solution of a carboxylate-containing substance to obtain a slurry;
heating the slurry such that reactions proceed to obtain an intermediate product; and
converting the intermediate product into crystals of the rare earth hydroxycarbonate, clusters of the rare earth hydroxycarbonate, or a mixture of crystals of the rare earth hydroxycarbonate and clusters of the rare earth hydroxycarbonate.

3. The method according to claim 1, wherein the carboxylate-containing substance is selected from:
(1) a C1-C6 monocarboxylic acid, or
(2) a mixture of a C1-C6 monocarboxylic acid and an ammonium salt of a C1-C6 monocarboxylic acid.

4. The method according to claim 3, wherein the C1-C6 monocarboxylic acid is one or more selected from the group consisting of formic acid, acetic acid and propionic acid, and
the mixture of a C1-C6 monocarboxylic acid and an ammonium salt of a C1-C6 monocarboxylic acid is selected from the group consisting of a mixture of formic acid and ammonium formate, a mixture of acetic acid and ammonium acetate, or a mixture of propionic acid and ammonium propionate.

5. The method according to claim 1, wherein the amount of the carboxylate-containing substance is 1-9% of the theoretical number of moles of the carboxylate-containing substance that is needed for a complexation reaction between the carboxylate-containing substance and a rare earth element in the rare earth carbonate; and
the concentration of the carboxylate-containing substance in the aqueous solution thereof is 0.015 to 0.15 mol/L.

6. The method according to claim 1, wherein heating the slurry such that reactions proceed comprises heating the slurry to a temperature of 50-100° C. such that reactions proceed for 10-600 min.

7. The method according to claim 1, further comprising:
performing solid-liquid separation after converting the intermediate product into crystals of the rare earth hydroxycarbonate, clusters of the rare earth hydroxycarbonate, or the mixture of crystals of the rare earth hydroxycarbonate and clusters of the rare earth hydroxycarbonate, and
recycling the resulting liquid as an aqueous solution of the carboxylate-containing substance.

8. The method according to claim 1, wherein the rare earth carbonate contains Cl⁻, SO₄²⁻, and NO₃⁻ in a total content of greater than 120 ppm, and the rare earth hydroxycarbonate contains Cl⁻, SO₄²⁻, and NO₃⁻ in a total content of 50 ppm or less; and
the rare earth hydroxycarbonate has an average particle diameter D₅₀ of less than 5.5 μm.

9. A method for increasing the rate of phase conversion in the course of preparing a rare earth hydroxycarbonate from a rare earth carbonate, the method comprising:
preparing the rare earth hydroxycarbonate from the rare earth carbonate with a carboxylate-containing substance.

10. The method according to claim 9, wherein the carboxylate-containing substance is selected from:
(1) a C1-C6 monocarboxylic acid, or
(2) a mixture of a C1-C6 monocarboxylic acid and an ammonium salt of a C1-C6 monocarboxylic acid.

11. The method according to claim 2, wherein the carboxylate-containing substance is selected from:
(1) a C1-C6 monocarboxylic acid, or
(2) a mixture of a C1-C6 monocarboxylic acid and an ammonium salt of a C1-C6 monocarboxylic acid.

12. The method according to claim 2, wherein the amount of the carboxylate-containing substance is 1-9% of the theoretical number of moles of the carboxylate-containing substance that is needed for a complexation reaction between the carboxylate-containing substance and a rare earth element in the rare earth carbonate; and
the concentration of the carboxylate-containing substance in the aqueous solution thereof is 0.015 to 0.15 mol/L.

13. The method according to claim 2, wherein heating the slurry such that reactions proceed comprises heating the slurry to a temperature of 50-100° C. such that reactions proceed for 10-600 min.

14. The method according to claim 2, further comprising:
performing solid-liquid separation after converting the intermediate product into crystals of the rare earth hydroxycarbonate, clusters of the rare earth hydroxycarbonate, or the mixture of crystals of the rare earth hydroxycarbonate and clusters of the rare earth hydroxycarbonate, and
recycling the resulting liquid as an aqueous solution of the carboxylate-containing substance.

15. The method according to claim 2, wherein the rare earth carbonate contains Cl⁻, SO₄²⁻, and NO₃⁻ in a total content of greater than 120 ppm, and the rare earth hydroxycarbonate contains Cl⁻, SO₄²⁻, and NO₃⁻ in a total content of 50 ppm or less; and
the rare earth hydroxycarbonate has an average particle diameter D₅₀ of less than 5.5 μm.
